(19) United States
(12) Patent Application Publication
(10) Pub. No.: US 2005/0179932 A1
(43) Pub. Date: Aug. 18, 2005

(54) Print control method and image forming apparatus

(76) Inventor: Yoshihiro Matsuda, Tokyo (JP)

Correspondence Address: RABIN & Berdo, PC, 1101 14TH STREET, NW, SUITE 500, WASHINGTON, DC, 20005, US

(21) Appl. No.: 11/046,881

(22) Filed: Feb. 1, 2005

(30) Foreign Application Priority Data
Feb. 2, 2004 (JP) JP2004-025382

(51) Int. Cl. G06K 15/02; G06F 3/12; G06F 17/00; G06F 17/21

(52) U.S. Cl. 358/1.14; 358/1.11; 715/530; 358/527; 715/542; 358/1.18

(57) ABSTRACT

In an image forming apparatus, an inconvenient image expressing format in which it is possible to presume that it occurs in a reconstructed image is predicted and set as a format to be excluded, and this format is transmitted to the image forming apparatus. A feature of a print format is extracted from print data in accordance with the format to be excluded and compared therewith. If they differ, printing of the print data is started. If they coincide, re-editing of the image is requested to an image processing apparatus. Upon previewing, an amount of data which is returned to the image processing apparatus from the image forming apparatus can be reduced.

### BACKGROUND OF THE INVENTION

1. Field of the Invention

The invention relates to a print control method in a print system comprising an image processing apparatus such as a PC (personal computer) or the like and an image forming apparatus such as a printer or the like and to the image forming apparatus.

2. Related Background Art

A document formed by an image processing apparatus such as a PC or the like is converted into print data by a printer driver built in the image processing apparatus. The print data is sent to an image forming apparatus through a line such as a LAN (local area network) or the like. The print data sent to the image forming apparatus is edited, expanded, and outputted as a print image. Usually, after the document formed by the image processing apparatus is expanded into bit map data in the image forming apparatus, it is returned from the image forming apparatus to the image processing apparatus and previewed onto a display by application software installed in the image processing apparatus, so that a print format is confirmed.

Since all print documents expanded into the bit map data are returned, when the number of print sheets is large, an amount of data which is returned from the image forming apparatus to the image processing apparatus is extremely large. Particularly, if the image forming apparatus is a network printer, such an inconvenience that the specific user occupies the network printer for a long time and working efficiency of the image forming system deteriorates occurs.

It is a problem to be solved by the invention that since all of the print documents expanded into the bit map data are returned as mentioned above, when the number of print sheets is large, the amount of data which is returned from the image forming apparatus to the image processing apparatus is extremely large, so that the specific user occupies the network printer for a long time and working efficiency of the image forming system deteriorates.

### SUMMARY OF THE INVENTION

It is an object of the invention to provide a print control method in a print system comprising an image processing apparatus such as a PC (personal computer) or the like and an image forming apparatus such as a printer or the like and to provide the image forming apparatus.

According to the present invention, there is provided a print control method of an image forming apparatus, comprising the steps of:

setting a feature condition, as a setting feature condition, of an image which is designated from an image processing apparatus;

extracting a feature portion from image data received from the image processing apparatus and discriminating whether or not the feature portion satisfies the setting feature condition; and

if it is determined that the feature portion satisfies the setting feature condition, notifying the image processing apparatus of such a fact.

Moreover, in the print control method, the notification denotes that re-editing of the image data is obtained.

Moreover, in the print control method, in the discriminating step, whether or not the feature portion satisfies the setting feature condition is discriminated on a unit basis of a page which is printed by the image forming apparatus, and in the notifying step, if it is determined that the feature portion satisfies the setting feature condition, corresponding page information is notified on a unit basis of the page which is printed by the image forming apparatus.

Moreover, in the print control method, the setting feature condition is a boundary condition of a plurality of images.

Moreover, in the print control method, the setting feature condition is directions of a plurality of images.

Moreover, in the print control method, the setting feature condition is a character size.

Moreover, in the print control method, the setting feature condition is a character size corresponding to a character font.

Moreover, in the print control method, the setting feature condition is the number of media which are printed by the image forming apparatus.

Further, according to the present invention, there is also provided an image forming apparatus comprising:

a feature condition inputting unit which sets a feature condition, as a setting feature condition, of an image which is designated from an image processing apparatus;

a feature condition discriminating unit which extracts a feature portion from image data received from the image processing apparatus and discriminates whether or not the feature portion satisfies the setting feature condition; and

a notifying unit which, if it is determined that the feature portion satisfies the setting feature condition, notifies the image processing apparatus of such a fact.

Moreover, in the image forming apparatus, the notifying unit obtains re-editing of the image data from the image processing apparatus.

Moreover, in the image forming apparatus, the feature condition discriminating unit discriminates whether or not the feature portion satisfies the setting feature condition on a unit basis of a page which is printed by the image forming apparatus, and if it is determined that the feature portion satisfies the setting feature condition, the notifying unit notifies the image processing apparatus of corresponding page information on a unit basis of the page which is printed by the image forming apparatus.

Moreover, in the image forming apparatus, the setting feature condition is a boundary condition of a plurality of images.

Moreover, in the image forming apparatus, the setting feature condition is directions of a plurality of images.

Moreover, in the image forming apparatus, the setting feature condition is a character size.

Moreover, in the image forming apparatus, the setting feature condition is a character size corresponding to a character font.

Moreover, in the image forming apparatus, the setting feature condition is the number of media which are printed by the image forming apparatus.

In the present invention, without returning all of the print documents expanded into the bit map data, whether the print form is acceptable are detected. Only when the print form is detected to be not acceptable, re-edit request is executed. Thus, such an effect that if the image forming apparatus is the network printer, the specific user does not occupy the network printer for a long time and the working efficiency of the image forming system can be raised is obtained.

The above and other objects and features of the present invention will become apparent from the following detailed description and the appended claims with reference to the accompanying drawings.

### BRIEF DESCRIPTION OF THE DRAWINGS

FIG. 1 is a block diagram (part 1) of a construction of the invention;

FIG. 2 is a block diagram (part 2) of a construction of the invention;

FIGS. 3A and 3B are explanatory diagrams of format detection information of an inconvenient example [1];

FIG. 4 is a flowchart (part 1) for the operation of the inconvenient example [1];

FIG. 5 is a display diagram of a print format of the inconvenient example [1];

FIG. 6 is a flowchart (part 2) for the operation of the inconvenient example [1];

FIG. 7 is a flowchart for an extracting process of the inconvenient example [1];

FIG. 8 is a flowchart for a comparing process of the inconvenient example [1];

FIGS. 9A and 9B are explanatory diagrams of format detection information of an inconvenient example [2];

FIG. 10 is a flowchart (part 1) for the operation of the inconvenient example [2];

FIG. 11 is a display diagram of a print format of the inconvenient example [2];

FIG. 12 is a flowchart (part 2) for the operation of the inconvenient example [2];

FIG. 13 is a flowchart for an extracting process of the inconvenient example [2];

FIG. 14 is a flowchart for a comparing process of the inconvenient example [2];

FIGS. 15A and 15B are explanatory diagrams of format detection information of an inconvenient example [3];

FIG. 16 is a flowchart (part 1) for the operation of the inconvenient example [3];

FIG. 17 is a display diagram of a print format of the inconvenient example [3];

FIG. 18 is a flowchart (part 2) for the operation of the inconvenient example [3];

FIG. 19 is a flowchart for an extracting process of the inconvenient example [3];

FIG. 20 is a flowchart for a comparing process of the inconvenient example [3];

FIGS. 21A and 21B are explanatory diagrams of format detection information of an inconvenient example [4];

FIG. 22 is a flowchart (part 1) for the operation of the inconvenient example [4];

FIG. 23 is a display diagram of a print format of the inconvenient example [4];

FIG. 24 is a flowchart (part 2) for the operation of the inconvenient example [4];

FIG. 25 is a flowchart for an extracting process of the inconvenient example [4]; and

FIG. 26 is a flowchart for a comparing process of the inconvenient example [4].

### DETAILED DESCRIPTION OF THE PREFERRED EMBODIMENTS

The invention can be realized without increasing the number of parts by using a control method based on a computer program which enables all or some of a user setting information forming step, a user setting information transmitting step, an information type discriminating step, a print format feature extracting step, a feature comparing step, a comparison result discriminating step, and a re-edition requesting step to be stored into a computer-readable recording medium.

[Embodiment 1]

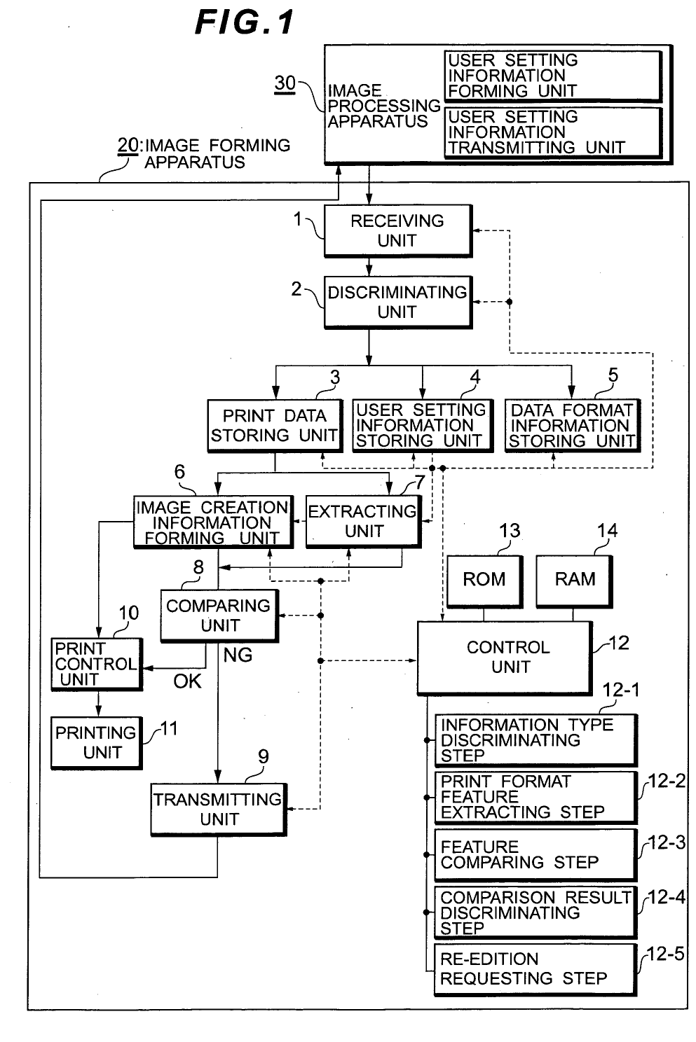

FIG. 1 is a block diagram (part 1) of a construction of the invention.

This diagram shows an image forming apparatus in an image forming system for executing a control method according to the invention.

Referring to FIG. 1, an image forming apparatus 20 comprises: a receiving unit 1; a discriminating unit 2; a print data storing unit 3; a user setting information storing unit 4; a data format information storing unit 5; an image creation information forming unit 6; an extracting unit 7; a comparing unit 8; a transmitting unit 9; a print control unit 10; a printing unit 11; a control unit 12; a ROM 13; and a RAM 14.

The receiving unit 1 is an interface (I/F) portion for receiving various information such as print data, user setting information, data format information, and the like from an image processing apparatus 30.

The discriminating unit 2 is a portion for receiving various information from the receiving unit 1 and dividing it into the print data, user setting information, data format information, and the like in accordance with an information type discriminating step 12-1 of the control unit 12.

The print data storing unit 3 is a memory for storing the print data selected by the discriminating unit 2.

The user setting information storing unit 4 is a memory for storing the user setting information selected by the discriminating unit 2.

The data format information storing unit 5 is a memory for storing the data format information selected by the discriminating unit 2.

The image creation information forming unit 6 is a portion for converting the print data into bit map data.

The extracting unit 7 is a portion for extracting a feature of a print format from the print data in accordance with an expressing format, which will be explained hereinafter, to be excluded which is sent from the image processing apparatus 30 and in accordance with a print format feature extracting step 12-2 of the control unit 12.

The comparing unit 8 is a portion for comparing the feature of the print format extracted by the extracting unit 7 with the expressing format, which will be explained hereinafter, to be excluded in accordance with a feature comparing step 12-3 of the control unit 12. Further, the comparing unit 8 is a portion for discriminating whether or not the expressing format, which will be explained hereinafter, to be excluded coincides with the feature of the print format extracted by the extracting unit 7 on the basis of a predetermined discrimination reference from a comparison result in accordance with a comparison result discriminating step 12-4 of the control unit 12.

The transmitting unit 9 is a portion for requesting re-editing of a document (concept including an image) in accordance with a re-edition requesting step 12-5 of the control unit 12 by notifying the image processing apparatus 30 of a fact indicative of the coincidence if it is determined from a discrimination result of the comparing unit 8 that the feature of the print format extracted by the extracting unit 7 coincides with the expressing format, which will be explained hereinafter, to be excluded.

The print control unit 10 is a portion for starting a printing process of the print data if it is determined from a discrimination result of the comparing unit 8 that the feature of the print format extracted by the extracting unit 7 does not coincide with the expressing format, which will be explained hereinafter, to be excluded.

The printing unit 11 is a portion for executing the printing on the basis of control of the print control unit 10.

The control unit 12 is a CPU (central processing unit) for controlling the image forming apparatus 20 in accordance with the information type discriminating step 12-1, print format feature extracting step 12-2, feature comparing step 12-3, comparison result discriminating step 12-4, and re-edition requesting step 12-5.

The information type discriminating step 12-1 is a control procedure for the CPU to allow the discriminating unit 2 to receive the various information from the receiving unit 1 and dividing it into the print data, user setting information, data format information, and the like. The information type discriminating step 12-1 is a computer program which can be stored into a computer-readable recording medium.

The print format feature extracting step 12-2 is a control procedure for the CPU to allow the extracting unit 7 to extract the print format of the print data from the print data in accordance with the format, which will be explained hereinafter, to be excluded which is sent from the image processing apparatus 30. The print format feature extracting step 12-2 is a computer program which can be stored into the computer-readable recording medium.

The feature comparing step 12-3 is a control procedure for the CPU to allow the comparing unit 8 to compare the feature of the print format extracted by the extracting unit 7 with the format, which will be explained hereinafter, to be excluded which is sent from the image processing apparatus 30. The feature comparing step 12-3 is a computer program which can be stored into the computer-readable recording medium.

The comparison result discriminating step 12-4 is a control procedure for the CPU to discriminate whether or not the feature of the print format extracted by the extracting unit 7 coincides with the format, which will be explained hereinafter, to be excluded which is sent from the image processing apparatus 30 on the basis of the predetermined discrimination reference from the comparison result of the comparing unit 8. The comparison result discriminating step 12-4 is a computer program which can be stored into the computer-readable recording medium.

The re-edition requesting step 12-5 is a control procedure for the CPU to allow the transmitting unit 9 to notify the image processing apparatus 30 of the fact indicative of the coincidence if it is determined from the discrimination result of the comparing unit 8 that the format, which will be explained hereinafter, to be excluded coincides with the feature of the print format and request the re-editing of a document (concept including an image). The re-edition requesting step 12-5 is a computer program which can be stored into the computer-readable recording medium.

The ROM 13 is a read only memory for storing the information type discriminating step 12-1, print format feature extracting step 12-2, feature comparing step 12-3, comparison result discriminating step 12-4, re-edition requesting step 12-5, and data necessary for executing such a control procedure.

Further, print format detection information to extract the feature of the print format of the print data from the print data, a predetermined discrimination reference which is used to discriminate whether or not the feature of the print format extracted by the extracting unit 7 coincides with the format, which will be explained hereinafter, to be excluded, and the like have previously been stored in the ROM 13 in accordance with the format to be excluded.

The RAM 14 is a random access memory which is temporarily used for an arithmetic operation or the like of the data during the execution of the information type discriminating step 12-1, print format feature extracting step 12-2, feature comparing step 12-3, comparison result discriminating step 12-4, and re-edition requesting step 12-5.

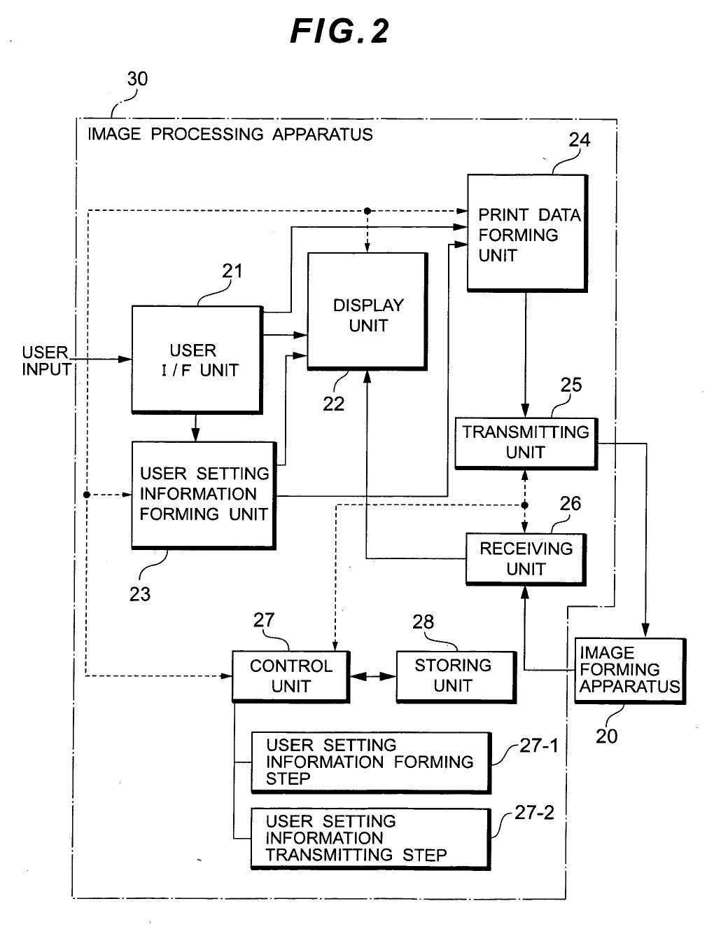

FIG. 2 is a block diagram (part 2) of a construction of the invention.

This diagram shows the image processing apparatus of the image forming system to execute the control procedure according to the invention.

Referring now to the diagram, the image processing apparatus comprises: a user interface (I/F) unit 21; a display unit 22; a user setting information forming unit 23; a print data forming unit 24; a transmitting unit 25; a receiving unit 26; a control unit 27; and a storing unit 28.

The user I/F unit 21 is a portion for playing a role of an interface between the operator and the image processing apparatus 30 in order to allow the operator to input the print data, user setting information, data format information, and the like.

The display unit 22 is a display for displaying the information inputted by the operator from the user I/F unit 21, a re-editing request of a document which is received by the image processing apparatus 30 from the image forming apparatus 20, or the like, thereby notifying him of it.

The user setting information forming unit 23 is a portion for setting an inconvenient image expressing format, as a format to be excluded, in which it is presumed that it is generated in a document edited by the image processing apparatus 30 in accordance with a user setting information forming step 27-1 of the control unit 27. Ordinarily, pre-registered formats to be excluded are displayed as properties of the image processing unit onto the display unit 22. The operator selects a desired one of them, so that the selected format is set.

The print data forming unit 24 is a portion for converting the document inputted by the operator or other information into the print data, data format information, user setting information, or the like and forming a print job.

The transmitting unit 25 is a portion for transmitting the print job to the image forming apparatus 20 in accordance with a user setting information transmitting step 27-2 of the control unit 27.

The receiving unit 26 is a portion for receiving the re-editing request or the like of the document which is sent from the image forming apparatus 20 and sending it to the display unit 22.

The control unit 27 is a CPU (central processing unit) for controlling the image processing apparatus 30 in accordance with the user setting information forming step 27-1 and the user setting information transmitting step 27-2.

The user setting information forming step 27-1 is a control procedure for the CPU to allow the user setting information forming unit 23 to preset the inconvenient image expressing format, as a format to be excluded, in which it is presumed that it is generated in the document edited by the image processing apparatus 30. The user setting information forming step 27-1 is a computer program which can be stored into a computer-readable recording medium.

The user setting information transmitting step 27-2 is a control procedure for the CPU to allow the transmitting unit 25 to transmit the print job formed by the print data forming unit 24 to the image forming apparatus. The user setting information transmitting step 27-2 is a computer program which can be stored into a computer-readable recording medium.

The storing unit 28 is a memory for allowing the control unit 27 to store the user setting information forming step 27-1 and the user setting information transmitting step 27-2 and temporarily storing the data that is necessary during the execution of those computer control programs.

The operation of the embodiment 1 will now be described.

The following four examples [1] to [4] are mentioned as formats to be excluded and the operation will be explained in order.
[1] An execution error in N-up printing in which original images of a plurality of pages (N pages) are reconstructed on a sheet of one page.
[2] An execution error in the N-up printing in which original images of a plurality of pages (N pages) are reconstructed on a sheet of one page in the different directions every original image.
[3] Appearance of characters whose sizes are equal to or less than a predetermined font size in the reconstructed image.
[4] An execution error in the N-up printing in which original images of a plurality of pages (N pages) are reconstructed on both sides of the sheet.

Explanation will now be made with respect to the operation regarding [1] the execution error in the N-up printing in which the original images of a plurality of pages (N pages) are reconstructed on the sheet of one page.

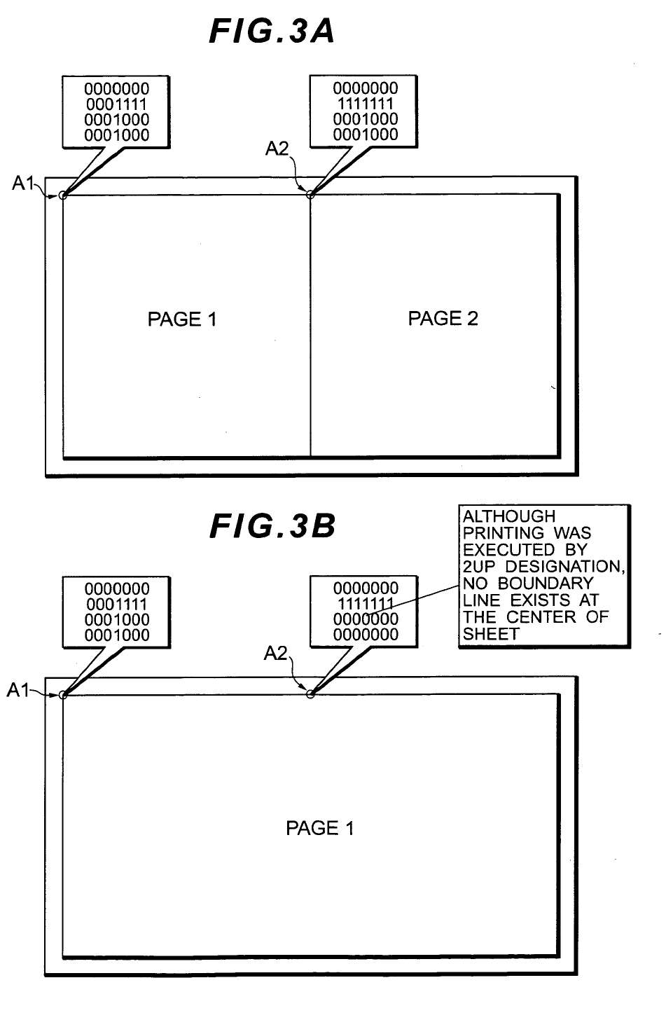

FIGS. 3A and 3B are explanatory diagrams of format detection information of the inconvenient example [1].

FIG. 3A shows a normal state. FIG. 3B shows an inconvenient state. Explanation will now be made on the assumption that the N-up printing is limited to “2-up” and the number of original images is limited to three. In the normal state as shown in FIG. 3A, rules line information (edge of the original sheet) in which a numerical value “1” is aligned in the portrait direction is recognized in two predetermined areas A1 and A2 while an edge portion of the original sheet is used as a center. However, in FIG. 3B, the rules line information in which the numerical value “1” is aligned in the portrait direction is not recognized in the predetermined area A2. It is assumed that those print format detection information and the discrimination reference have already been stored in the ROM 13 (FIG. 1).

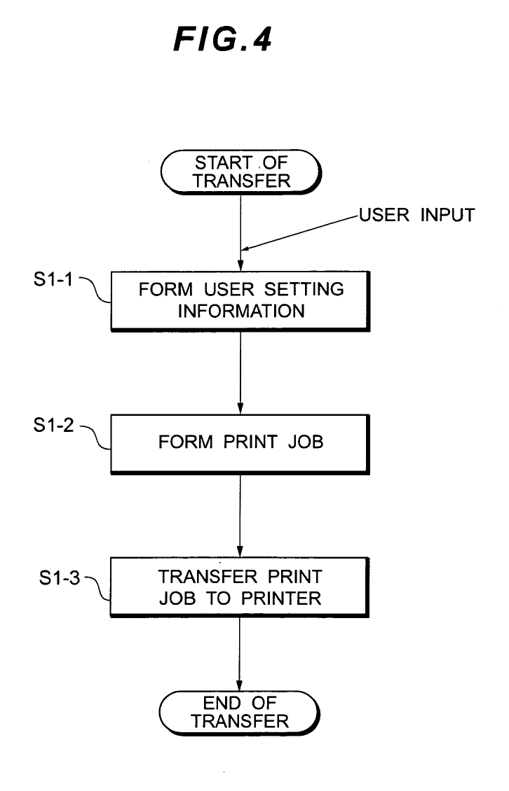

FIG. 4 is a flowchart (part 1) for the operation of the inconvenient example [1].

This diagram relates to the operation of the image processing apparatus 30 (FIG. 2).

Step S1-1

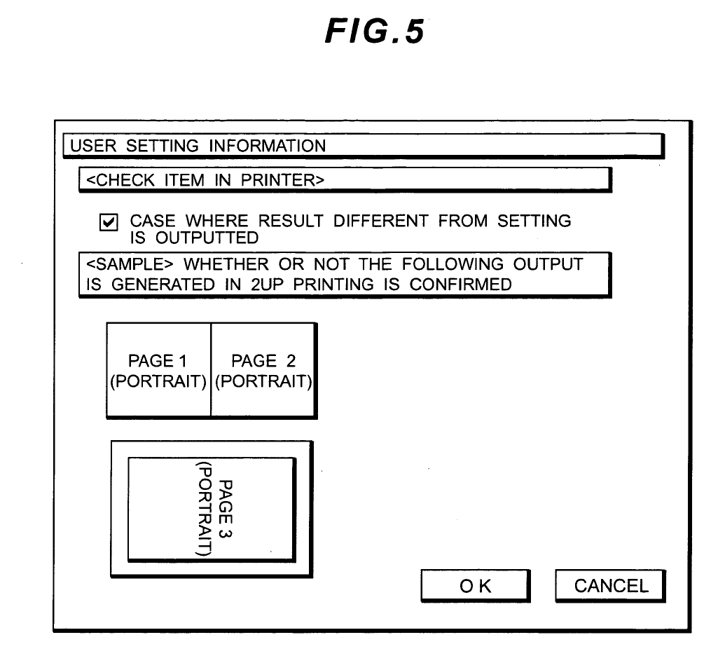

FIG. 5 is a display diagram of the print format of the inconvenient example [1].

In the diagram, (a) shows the state where two images comprising the original image of the first page and the original image of the second page are reconstructed in the portrait vertical direction through a ruled line, and (b) shows the state where one original image of the third page is reconstructed in the portrait lateral direction.

The operator selects the user setting information from a property displayed on the display unit 22 (FIG. 2) by using the user I/F unit 21 (FIG. 2) and selects the state of FIG. 5 as a print format to be excluded.

When an OK button shown in FIG. 5 is clicked, the print format to be excluded is immediately set by the user setting information forming unit 23 (FIG. 2). This step corresponds to the user setting information forming step 27-1.

Step S1-2

The print data forming unit 24 (FIG. 2) converts the document inputted by the operator or other information into the print data, data format information, user setting information, or the like and forms the print job.

Step S1-3

The print job is sent to the image forming apparatus 20 (FIG. 2) from the transmitting unit 25 (FIG. 2).

Steps S1-2 and S1-3 correspond to the user setting information transmitting step 27-2.

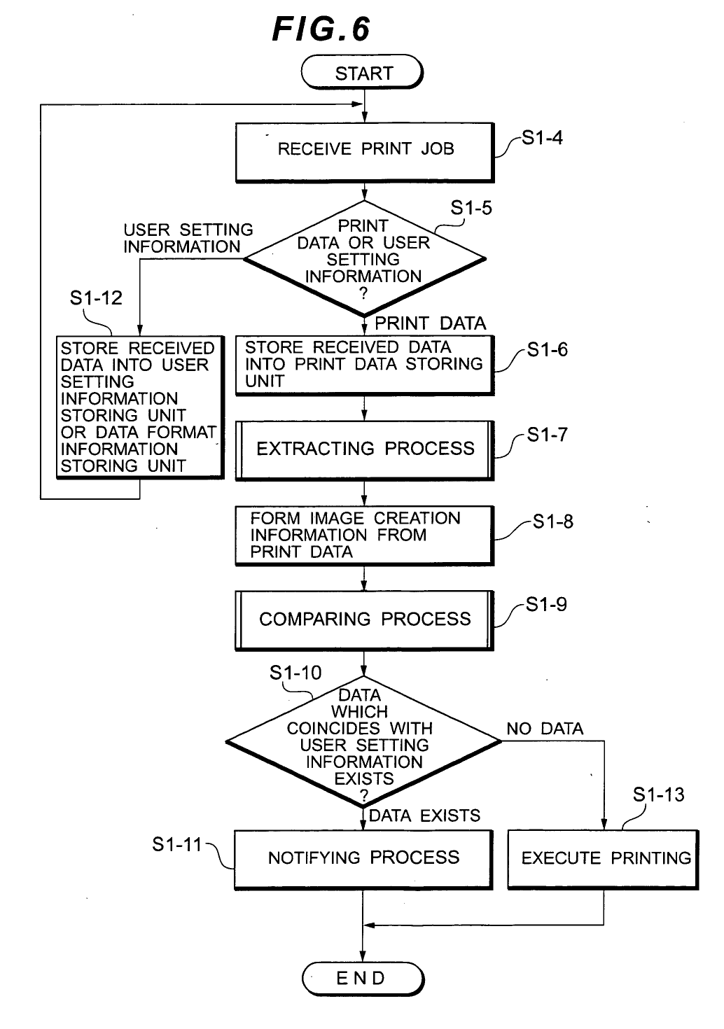

FIG. 6 is a flowchart (part 2) for the operation of the inconvenient example [1].

This diagram relates to the operation of the image forming apparatus 20 (FIG. 1).

Step S1-4

The receiving unit 1 (FIG. 1) receives the print job from the image processing apparatus 30 (FIG. 1).

Step S1-5

The discriminating unit 2 (FIG. 1) discriminates a type of print job received from the image processing apparatus 30 (FIG. 1), that is, it discriminates, one of the user setting information, the print data, and the data format information. If the print data is discriminated, the processing routine advances to step S1-6. If either the user setting information or the data format information other than the print data is discriminated, step S1-12 follows. This step corresponds to the information type discriminating step 12-1 (FIG. 1).

Step S1-6

The print data is stored in the print data storing unit 3 (FIG. 1).

Step S1-7

The extracting unit 7 (FIG. 1) reads out the format to be excluded from the user setting information stored in the user setting information storing unit 4 (FIG. 1) and extracts a feature of the print format corresponding to the format to be excluded from the print data.

This step corresponds to the print format feature extracting step 12-2 (FIG. 1). Details of this step will be described again hereinafter.

Step S1-8

The image creation information forming unit 6 (FIG. 1) converts the print data into bit map data (image creation information).

Step S1-9

The comparing unit 8 (FIG. 1) executes the operation for comparing the feature of the print format extracted in step S1-7 with the format to be excluded. This step corresponds to the feature comparing step 12-3 (FIG. 1). Details of this step will be described again hereinafter.

Step S1-10

The comparing unit 8 (FIG. 1) discriminates whether or not the expressing format to be excluded coincides with the feature of the print format on the basis of a predetermined discrimination reference from a comparison result. If they coincide, step S1-11 follows. If they do not coincide, step S1-13 follows. This step corresponds to the comparison result discriminating step 12-4 (FIG. 1).

Step S1-11

A notification showing that the print format of the print data coincides with the format to be excluded is transmitted from the transmitting unit 9 (FIG. 1) via the receiving unit 26 (FIG. 2) and displayed onto the display unit 22 (FIG. 2), and the processing flow is finished. This step corresponds to the re-edition requesting step 12-5 (FIG. 1).

Step S1-12

The user setting information is stored into the user setting information storing unit 4 (FIG. 1) and the data format information is stored into the data format information storing unit 5 (FIG. 1), respectively. After that, the processing routine is returned to step S1-4.

Step S1-13

The print control unit 10 (FIG. 1) controls the printing unit 11 and executes a printing process and the processing flow is finished.

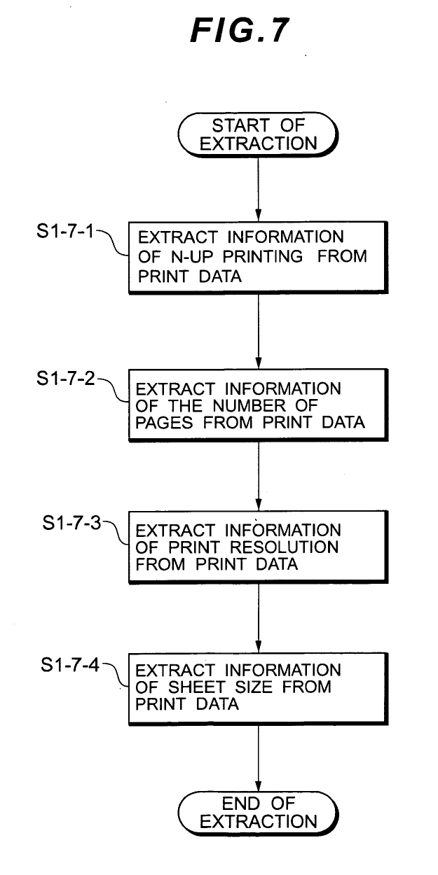

FIG. 7 is a flowchart for an extracting process of the inconvenient example [1].

Details of the print format feature extracting step 12-2 (FIG. 1) of step S1-7 will be described with reference to FIG. 7.

Explanation will be made by limiting to the case where original images of three pages are printed onto a sheet of the A4 letter size having a vertical ruled line at resolution of 1200 dpi.

Step S1-7-1

The extracting unit 7 (FIG. 1) extracts information showing that the print format is presumed to be 2up with a vertical ruled line from the print data.

Step S1-7-2

The extracting unit 7 (FIG. 1) extracts information showing that the original has three pages from the print data.

Step S1-7-3

The extracting unit 7 (FIG. 1) extracts information showing that the resolution is equal to 1200 dpi from the print data.

Step S1-7-4

The extracting unit 7 (FIG. 1) extracts information showing that the printing process is executed to the sheet of the A4 letter size from the print data. The processing routine advances to step S1-8 (FIG. 6).

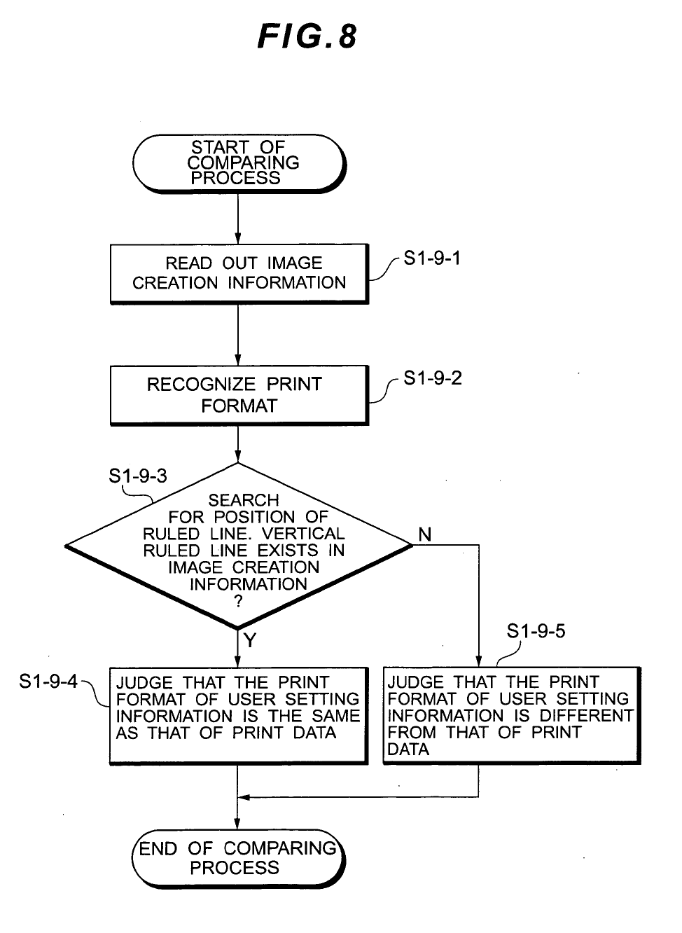

FIG. 8 is a flowchart for the comparing process of the inconvenient example [1].

Details of the feature comparing step 12-3 (FIG. 1) of step S1-9 will now be described with reference to FIG. 8.

Step S1-9-1

The comparing unit 8 (FIG. 1) receives the bit map data (image creation information) from the image creation information forming unit 6 (FIG. 1).

Step S1-9-2

The comparing unit 8 (FIG. 1) receives the feature of the print format from the extracting unit 7 (FIG. 1) and detects the print format detection information. That is, the bit map data in the predetermined areas A1 and A2 in which the edge portions of the original images of two pages which are reconstructed on the sheet of one page are used as centers as shown in FIG. 3 is read out. The positions of the predetermined areas A1 and A2 are easily calculated from the information extracted by the print format feature extracting step 12-2 (FIG. 1) of step S1-7.

Step S1-9-3

The comparing unit 8 (FIG. 1) discriminates whether or not the vertical ruled line information is included in the predetermined areas A1 and A2. If the vertical ruled line information is included, step S1-9-4 follows. If the vertical ruled line information is not included, step S1-9-5 follows.

Step S1-9-4

It is recognized that the vertical ruled line information is included and the processing routine advances to step S1-13 (FIG. 6).

Step S1-9-5

It is recognized that the vertical ruled line information is not included and the processing routine advances to step S1-11 (FIG. 6).

As described above, if [1] the execution error in the N-up printing in which the original images of a plurality of pages (N pages) are reconstructed on the sheet of one page is detected, the notification showing that the print format of the print data coincides with the format to be excluded is transmitted from the image forming apparatus 20 (FIG. 1) to the image processing apparatus (FIG. 2) and the processing flow is finished. If the execution error is not detected, the printing process is started as it is.

By using the control procedure described above, such a drawback that the N-up printing cannot be performed although it has been demanded or the like can be eliminated. Since the fact that the N-up printing is executed in accordance with the request can be easily confirmed, working efficiency of the print system can be improved. The portion (for example, the page number) where the execution error has been detected can be also notified. Only the page where the execution error has been detected can be also transmitted to image processing apparatus as bit map data.

The operation regarding [2] the execution error in the N-up printing in which original images of a plurality of pages (N pages) are reconstructed on the sheet of one page in the different directions every original image will be described hereinbelow.

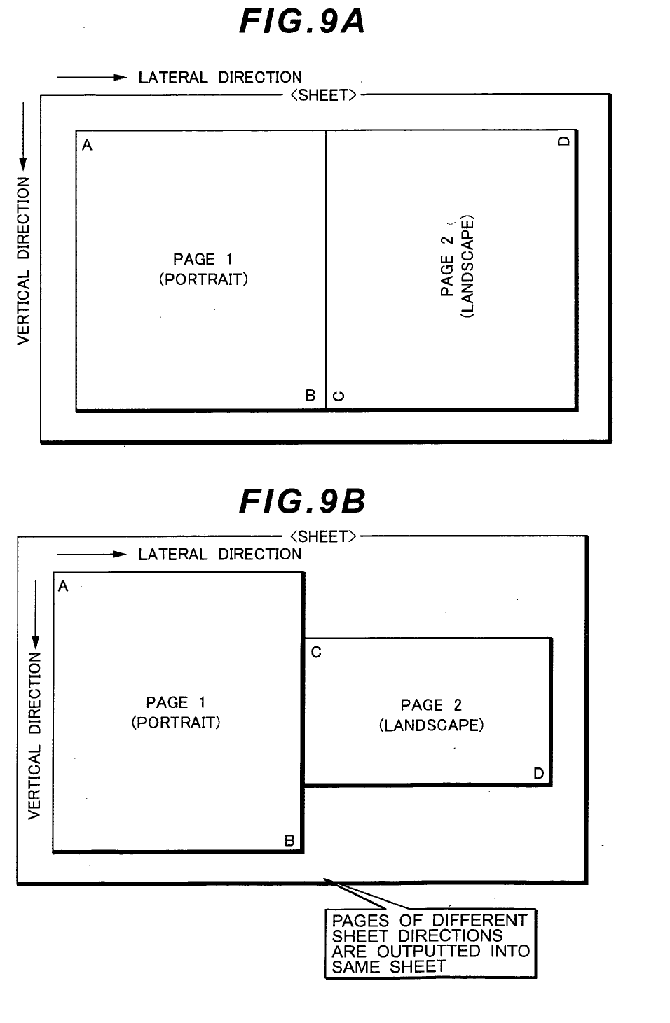

FIGS. 9A and 9B are explanatory diagrams of format detection information of the inconvenient example [2].

FIG. 9A shows a normal state. FIG. 9B shows an inconvenient state. Explanation will now be made on the assumption that the N-up printing is limited to “2-up”. In the normal state as shown in FIG. 9A, a drawing start portion A of the original image of the first page coincides with a position D in the vertical direction of a drawing end portion of the original sheet of the second page. In FIG. 9B, the vertical positions of all of the drawing start portion A of the original image of the first page, a drawing end portion B of the original sheet of the first page, a drawing start portion C of the original image of the second page, and a drawing end portion of the original sheet of the second page do not coincide. It is assumed that those print format detection information and the discrimination reference have already been stored in the ROM 13 (FIG. 1).

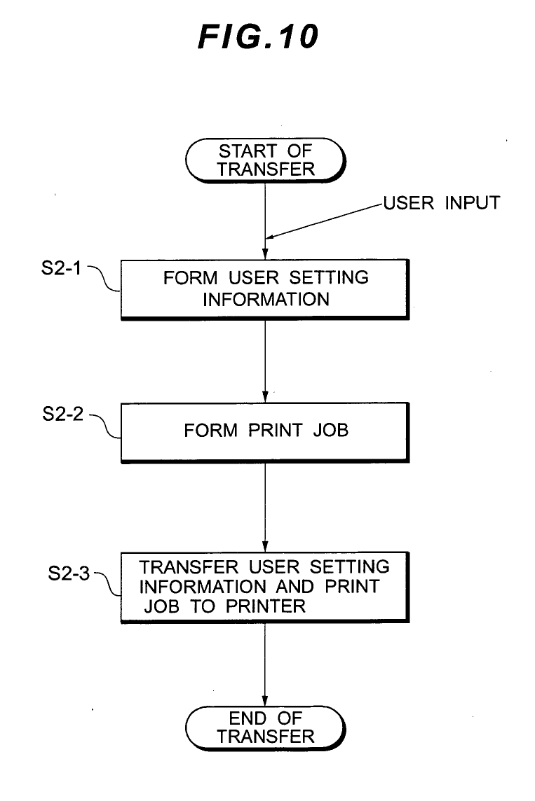

FIG. 10 is a flowchart (part 1) for the operation of the inconvenient example [2].

This diagram relates to the operation of the image processing apparatus 30 (FIG. 2).

Step S2-1

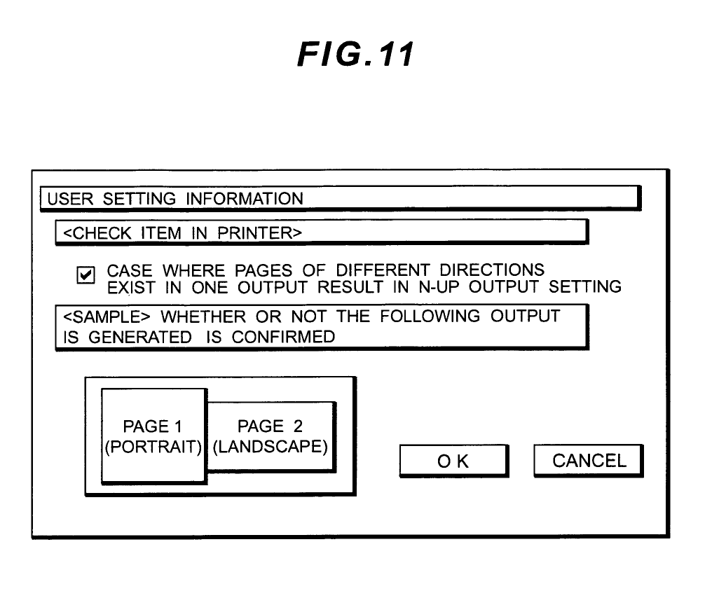

FIG. 11 is a display diagram of the print format of the inconvenient example [2].

In the diagram, the original image of the first page and the original image of the second page are not reconstructed in the different directions.

The operator selects the user setting information from a property displayed on the display unit 22 (FIG. 2) by using the user I/F unit 21 (FIG. 2) and selects the state of FIG. 11 as a print format to be excluded.

When an OK button shown in FIG. 11 is clicked, the format to be excluded is immediately set by the user setting information forming unit 23 (FIG. 2). This step corresponds to the user setting information forming step 27-1.

Step S2-2

The print data forming unit 24 converts the document inputted by the operator or other information into the print data, data format information, user setting information, or the like and forms the print job.

Step S2-3

The print job is sent to the image forming apparatus 20 (FIG. 2) from the transmitting unit 25 (FIG. 2).

Steps S2-2 and S2-3 correspond to the user setting information transmitting step 27-2.

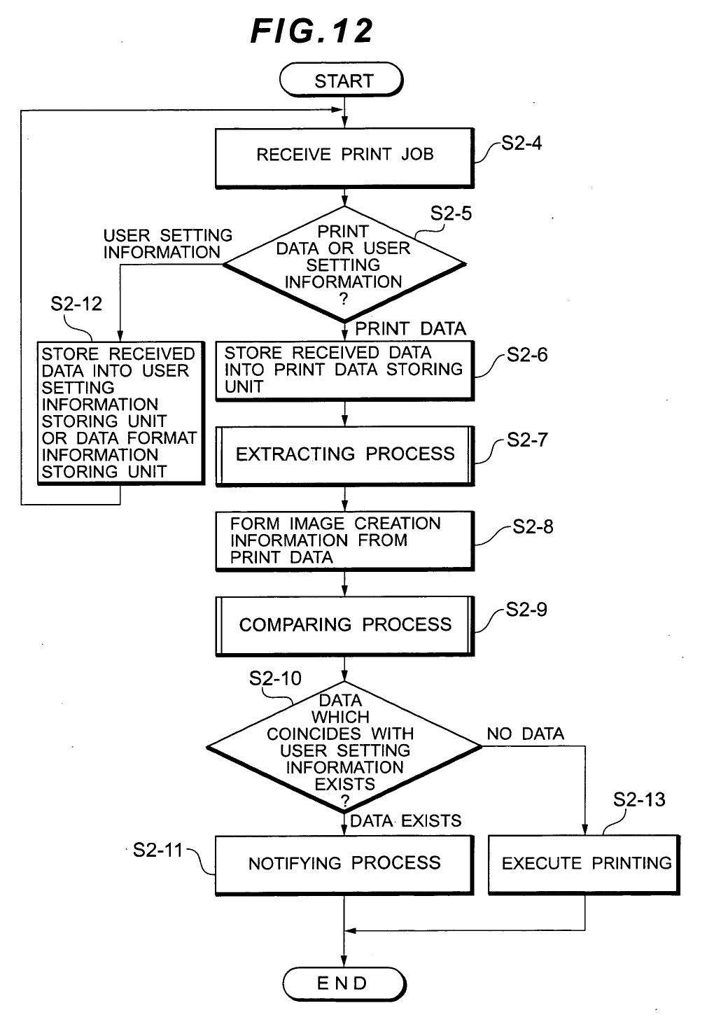

FIG. 12 is a flowchart (part 2) for the operation of the inconvenient example [2].

This diagram relates to the operation of the image forming apparatus 20 (FIG. 1).

Step S2-4

The receiving unit 1 (FIG. 1) receives the print job from the image processing apparatus 30 (FIG. 1).

Step S2-5

The discriminating unit 2 (FIG. 1) discriminates the type of print job received from the image processing apparatus 30 (FIG. 1), that is, it discriminates one of the user setting information, the print data, and the data format information. If the print data is discriminated, the processing routine advances to step S2-6. If either the user setting information or the data format information other than the print data is discriminated, step S2-12 follows. This step corresponds to the information type discriminating step 12-1 (FIG. 1).

Step S2-6

The print data is stored in the print data storing unit 3 (FIG. 1).

Step S2-7

The extracting unit 7 (FIG. 1) reads out the format to be excluded from the user setting information stored in the user setting information storing unit 4 (FIG. 1) and extracts the feature of the print format corresponding to the format to be excluded from the print data.

This step corresponds to the print format feature extracting step 12-2 (FIG. 1). Details of this step will be described again hereinafter.

Step S2-8

The image creation information forming unit 6 (FIG. 1) converts the print data into the bit map data (image creation information).

Step S2-9

The comparing unit 8 (FIG. 1) executes the operation for comparing the feature of the print format extracted in step S2-7 with the format to be excluded. This step corresponds to the feature comparing step 12-3 (FIG. 1). Details of this step will be described again hereinafter.

Step S2-10

The comparing unit 8 (FIG. 1) discriminates whether or not the expressing format to be excluded coincides with the feature of the print format on the basis of the predetermined discrimination reference from a comparison result. If they coincide, step S2-11 follows. If they do not coincide, step S2-13 follows. This step corresponds to the comparison result discriminating step 12-4 (FIG. 1).

Step S2-11

The notification showing that the feature of the print format coincides with the format to be excluded is transmitted from the transmitting unit 9 (FIG. 1) via the receiving unit 26 (FIG. 2) and displayed onto the display unit 22 (FIG. 2), and the processing flow is finished. This step corresponds to the re-edition requesting step 12-5 (FIG. 1).

Step S2-12

The user setting information is stored into the user setting information storing unit 4 (FIG. 1) and the data format information is stored into the data format information storing unit 5 (FIG. 1), respectively. After that, the processing routine is returned to step S2-4.

Step S2-13

The print control unit 10 (FIG. 1) controls the printing unit 11 and executes the printing process and the processing flow is finished.

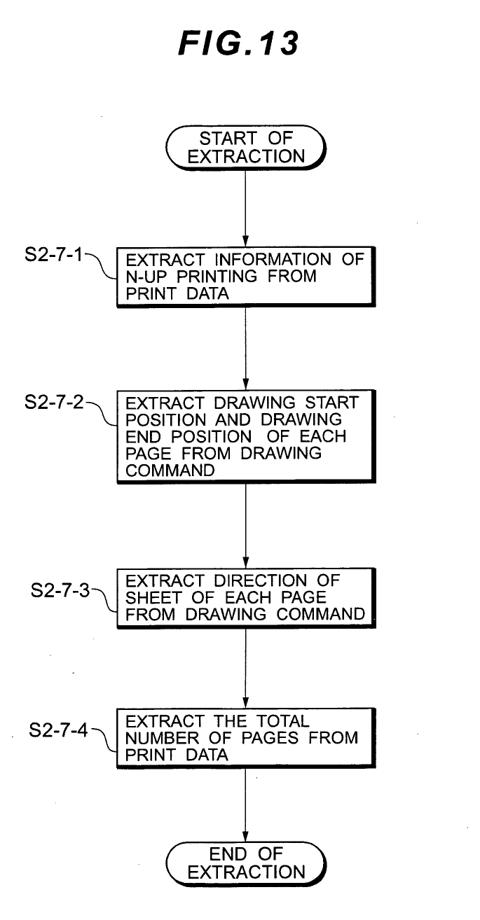

FIG. 13 is a flowchart for an extracting process of the inconvenient example [2].

Details of the print format feature extracting step 12-2 (FIG. 1) of step S2-7 will be described with reference to FIG. 13.

Explanation will be made by limiting to the case where original images of two pages are printed onto a sheet of the A4 letter size in different directions in the 2-up layout.

Step S2-7-1

The extracting unit 7 (FIG. 1) extracts information showing that the print format is presumed to be 2up of the different directions from the print data.

Step S2-7-2

The extracting unit 7 (FIG. 1) extracts the drawing start position and the drawing end position of each page of the original from the print data.

Step S2-7-3

The extracting unit 7 (FIG. 1) extracts the printing direction of each page.

Step S2-7-4

The extracting unit 7 (FIG. 1) extracts the total number of pages (2 here) from the print data and the processing routine advances to step S2-8 (FIG. 12).

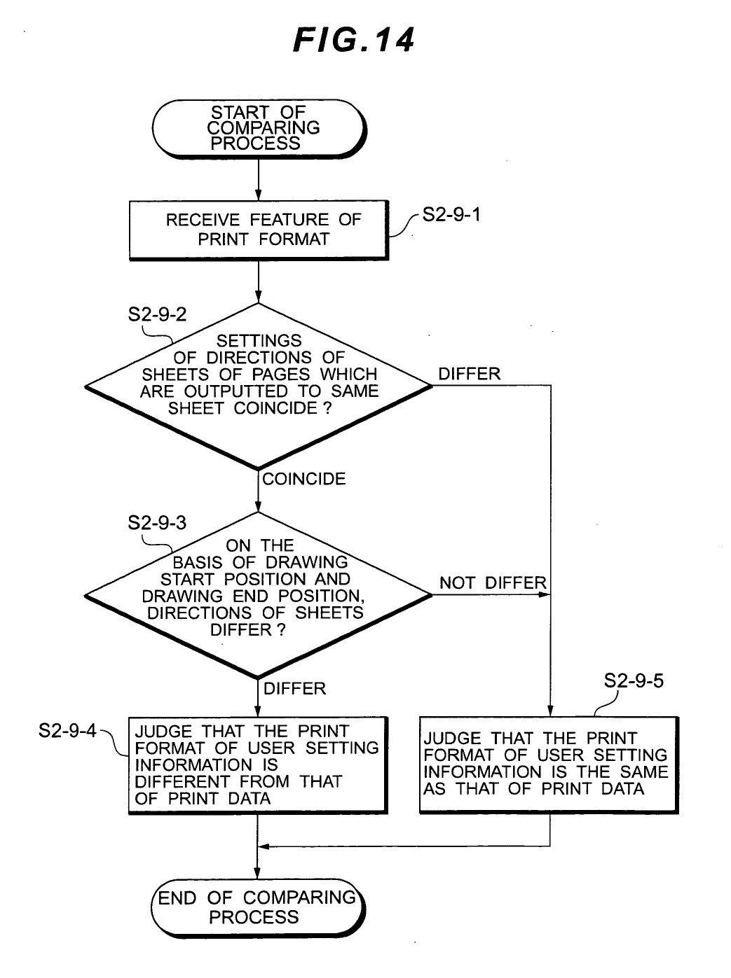

FIG. 14 is a flowchart for the comparing process of the inconvenient example [2].

Details of the feature comparing step 12-3 (FIG. 1) of step S2-9 will now be described with reference to FIG. 14.

Step S2-9-1

The comparing unit 8 (FIG. 1) receives the feature of the print format from the extracting unit 7 (FIG. 1).

Step S2-9-2

The comparing unit 8 (FIG. 1) receives the feature of the print format from the extracting unit 7 (FIG. 1) and detects the print format detection information. That is, it confirms whether or not the directions of the original images to be reconstructed on the same sheet coincide. If they coincide, step S2-9-5 follows. If they do not coincide, step S2-9-3 follows.

Step S2-9-3

The comparing unit 8 (FIG. 1) receives the feature of the print format from the extracting unit 7 (FIG. 1) and detects the print format detection information. That is, it confirms whether or not the directions of the sheets differ by checking whether or not the drawing start position A of the original image of the first page and the drawing end position D of the original image of the second page exist at the same position in the vertical direction. If they do not differ, step S2-9-5 follows. If they differ, step S2-9-4 follows.

Step S2-9-4

It is recognized that the drawing start position A of the original image of the first page and the drawing end position D of the original image of the second page do not exist at the same position in the vertical direction and the processing routine advances to step S2-11.

Step S2-9-5

It is recognized that the drawing start position A of the original image of the first page and the drawing end position D of the original image of the second page exist at the same position in the vertical direction and the processing routine advances to step S2-13.

As described above, if [2] the execution error in the N-up printing in which the original images of a plurality of pages (N pages) are reconstructed on the sheet of one page in the different directions every original image is detected, the notification showing that the print format of the print data coincides with the format to be excluded is transmitted from the image forming apparatus 20 (FIG. 1) to the image processing apparatus (FIG. 2) and the processing flow is finished. If the execution error is not detected, the printing process is started as it is.

By using the control procedure described above, such a drawback that the N-up printing cannot be performed in the different directions every original image although it has been demanded or the like can be eliminated. Since the fact that the N-up printing is executed in the different directions every original image in accordance with the request can be easily confirmed, the working efficiency of the print system can be improved.

The operation regarding [3] the appearance of the characters whose sizes are equal to or less than the predetermined font size in the reconstructed image will now be described.

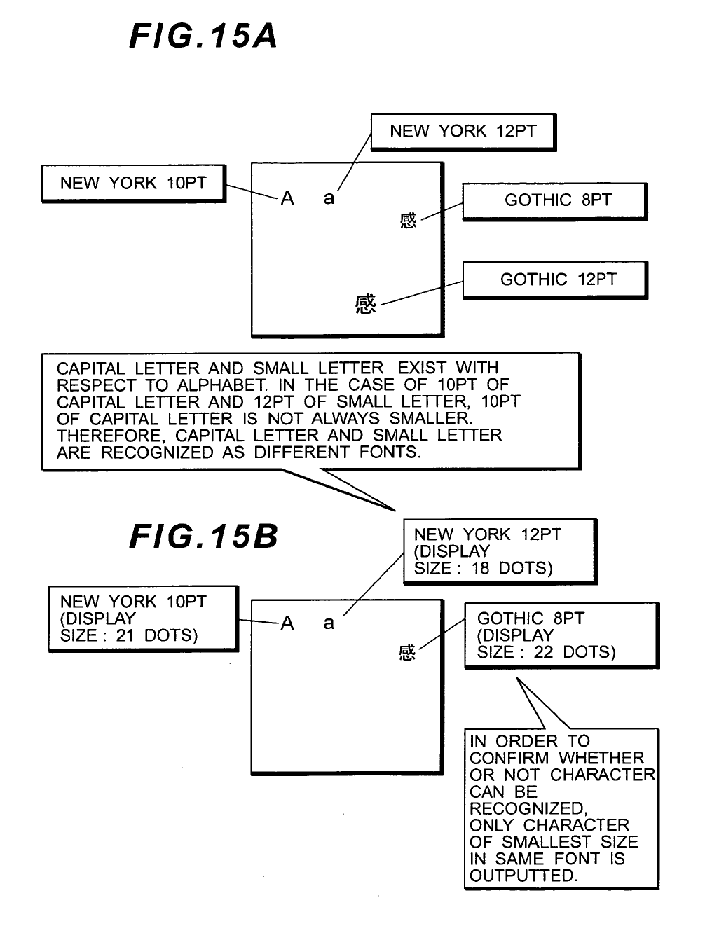

FIGS. 15A and 15B are explanatory diagrams of the format detection information of an inconvenient example [3].

FIG. 15A shows an unusable limit size of the font size.

A capital letter “A” and a small letter “a” have been set as alphabet here. This is because since a feeling about the size of the capital letter and that of the small letter are different even in the same font size, they are separately handled.

FIG. 15B shows an unusable limit size of the font size expressed by a display dot size. That is, if at least one character whose size is equal to or less than a display dot size shown in the diagram is included in the reconstructed document, this document corresponds to the format to be excluded. It is assumed that those print format detection information and discrimination reference have already been stored in the ROM 13 (FIG. 1).

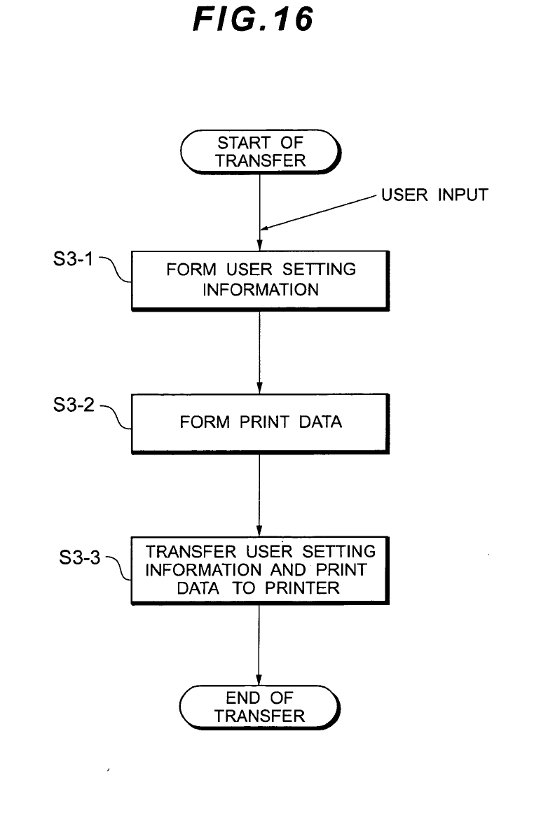

FIG. 16 is a flowchart (part 1) for the operation of the inconvenient example [3].

This flowchart relates to the operation of the image processing apparatus 30 (FIG. 2).

Step S3-1

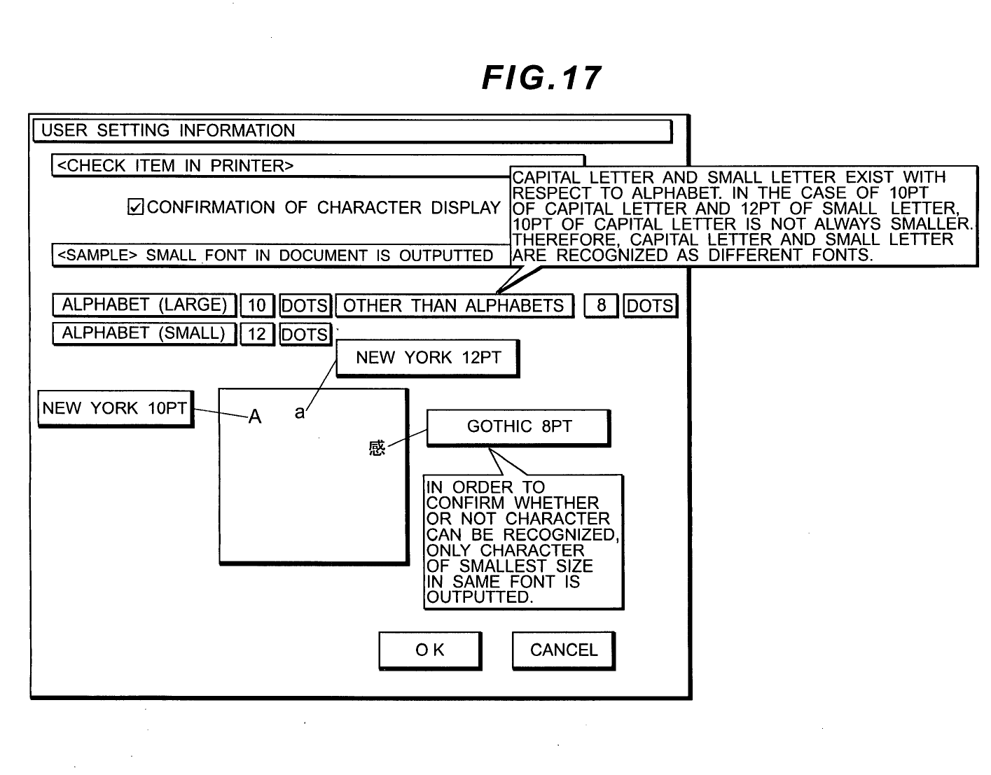

FIG. 17 is a display diagram of the print format of the inconvenient example [3].

In the diagram, (a) denotes an unusable limit font size of the capital letter of the alphabet; (b) an unusable limit font size of the small letter of the alphabet; (c) an unusable limit font size of a character other than the alphabet; and (d) an alphabet capital letter, an alphabet small letter, and a character (other than the alphabet) each of which is expressed by the unusable limit font size.

The operator selects the user setting information from the properties displayed on the display unit 22 (FIG. 2) by using the user I/F unit 21 (FIG. 2) and selects the state of FIG. 17 as a print format to be excluded.

When an OK button shown in FIG. 17 is clicked, the print format to be excluded is immediately set by the user setting information forming unit 23 (FIG. 2). This step corresponds to the user setting information forming step 27-1.

Step S3-2

The print data forming unit 24 converts the document inputted by the operator or other information into the print data, data format information, user setting information, or the like and forms the print job.

Step S3-3

The print job is sent to the image forming apparatus 20 (FIG. 2) from the transmitting unit 25 (FIG. 2).

Steps S3-2 and S3-3 correspond to the user setting information transmitting step 27-2.

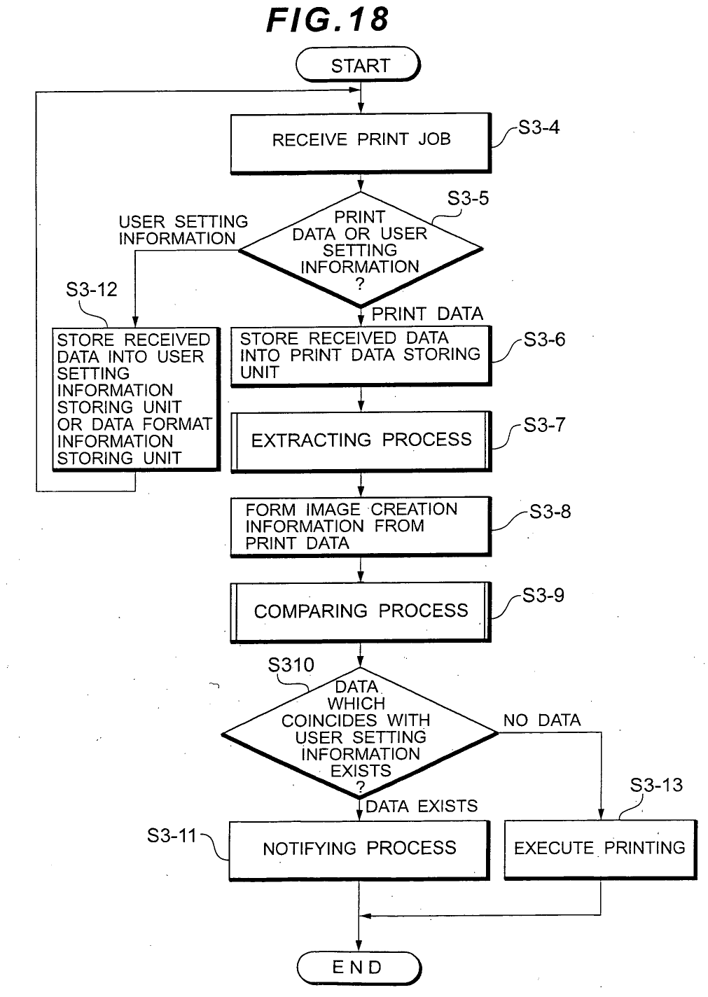

FIG. 18 is a flowchart (part 2) for the operation of the inconvenient example [3].

This diagram relates to the operation of the image forming apparatus 20 (FIG. 1).

Step S3-4

The receiving unit 1 (FIG. 1) receives the print job from the image processing apparatus 30 (FIG. 1).

Step S3-5

The discriminating unit 2 (FIG. 1) discriminates a type of print job received from the image processing apparatus 30 (FIG. 1), that is, it discriminates one of the user setting information, the print data, and the data format information. If the print data is discriminated, the processing routine advances to step S1-6. If either the user setting information or the data format information other than the print data is discriminated, step S1-12 follows. This step corresponds to the information type discriminating step 12-1 (FIG. 1).

Step S3-6

The print data is stored in the print data storing unit 3 (FIG. 1).

Step S3-7

The extracting unit 7 (FIG. 1) reads out the format to be excluded from the user setting information stored in the user setting information storing unit 4 (FIG. 1) and extracts the feature of the print format corresponding to the format to be excluded from the print data. This step corresponds to the print format feature extracting step 12-2 (FIG. 1). Details of this step will be described again hereinafter.

Step S3-8

The image creation information forming unit 6 (FIG. 1) converts the print data into bit map data (image creation information).

Step S3-9

The comparing unit 8 (FIG. 1) executes the operation for comparing the feature of the print format extracted in step S3-7 with the format to be excluded. This step corresponds to the feature comparing step 12-3 (FIG. 1). Details of this step will be described again hereinafter.

Step S3-10

The comparing unit 8 (FIG. 1) discriminates whether or not the expressing format to be excluded coincides with the feature of the print format on the basis of the predetermined discrimination reference from a comparison result. If they coincide, step S3-11 follows. If they do not coincide, step S3-13 follows. This step corresponds to the comparison result discriminating step 12-4 (FIG. 1).

Step S3-11

The notification showing that the print format of the print data coincides with the format to be excluded is transmitted from the transmitting unit 9 (FIG. 1) via the receiving unit 26 (FIG. 2) and displayed onto the display unit 22 (FIG. 2), and the processing flow is finished. This step corresponds to the re-edition requesting step 12-5 (FIG. 1).

Step S3-12

The user setting information is stored into the user setting information storing unit 4 (FIG. 1) and the data format information is stored into the data format information storing unit 5 (FIG. 1), respectively. After that, the processing routine is returned to step S3-4.

Step S3-13

The print control unit 10 (FIG. 1) controls the printing unit 11 and executes the printing process and the processing flow is finished.

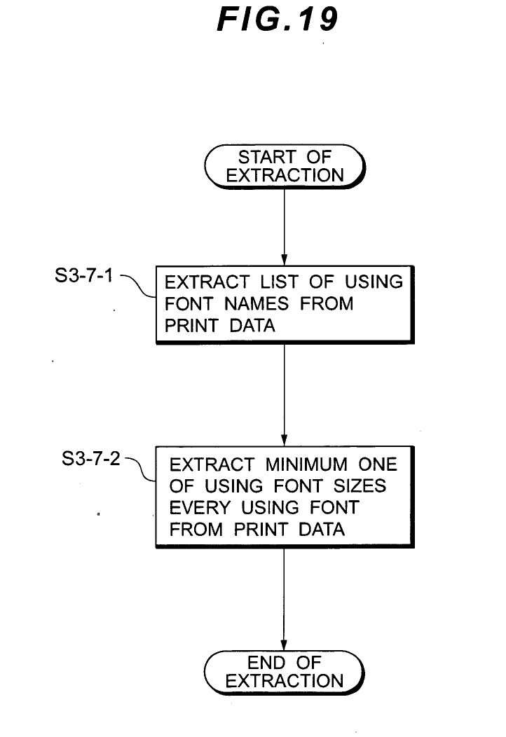

FIG. 19 is a flowchart for the extracting process of the inconvenient example [3].

Details of the print format feature extracting step 12-2 (FIG. 1) of step S3-7 will be described with reference to FIG. 19.

Explanation will be made by limiting to the case where original images of three pages are printed onto the sheet of the A4 letter size in the 2-up layout with a ruled line at resolution of 1200 dpi.

Step S3-7-1

The extracting unit 7 (FIG. 1) extracts a list of fonts which are used from the print data.

Step S3-7-2

The extracting unit 7 (FIG. 1) extracts the font size which is actually used every character from the print data and the processing routine advances to step S3-8 (FIG. 18).

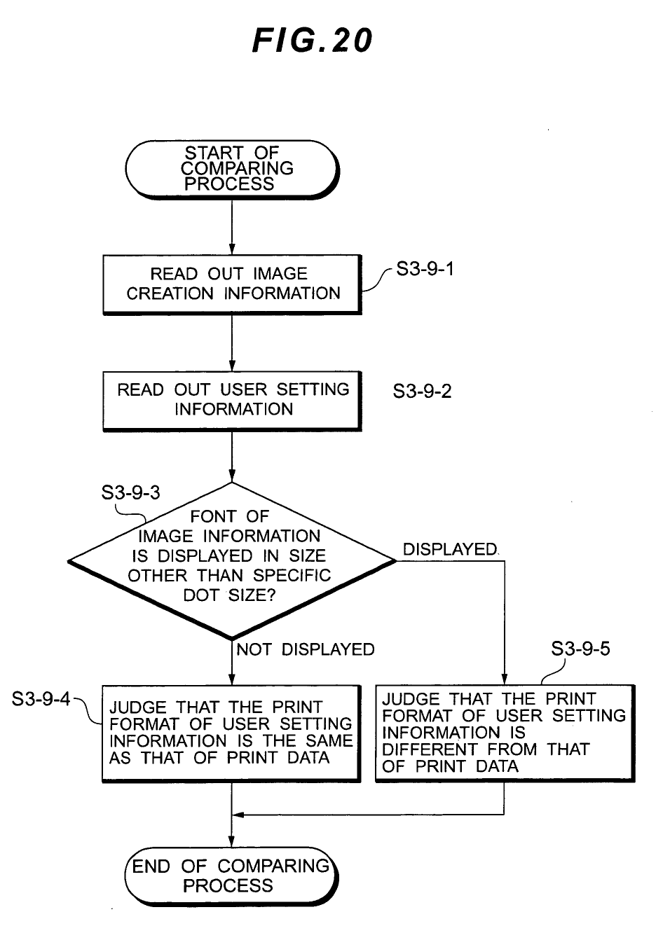

FIG. 20 is a flowchart for the comparing process of the inconvenient example [3].

Details of the feature comparing step 12-3 (FIG. 1) of step S3-9 will be described with reference to FIG. 20.

Step S3-9-1

The comparing unit 8 (FIG. 1) receives the bit map data (image creation information) from the image creation information forming unit 6 (FIG. 1).

Step S3-9-2

The comparing unit 8 (FIG. 1) receives the feature of the print format from the extracting unit 7 (FIG. 1) and detects the print format detection information. That is, the unusable limit size (for example, 20 dots) in which the font size is expressed by the display dot size is extracted.

Step S3-9-3

The comparing unit 8 (FIG. 1) compares the number of dots used in the bit map data with the unusable limit size. If a character in which the number of dots is smaller than the unusable limit size is not displayed, step S3-9-4 follows. If the character in which the number of dots is smaller than the unusable limit size is displayed, step S3-9-5 follows.

Step S3-9-4

When it is recognized that the character in which the number of dots is smaller than the unusable limit size is not displayed, step S3-13 follows.

Step S3-9-5

When it is recognized that the character in which the number of dots is smaller than the unusable limit size is displayed, step S3-11 follows.

As described above, if [3] the appearance of the characters whose sizes are equal to or less than the predetermined font size in the reconstructed image is detected, the notification showing that the print format of the print data coincides with the format to be excluded is sent from the image forming apparatus 20 (FIG. 1) to the image processing apparatus (FIG. 2), and the processing flow is finished. If the execution error is not detected, the printing process is started as it is.

By using the control procedure described above, it is demanded that the characters whose sizes are equal to or less than the predetermined font size do not appear in the reconstructed image. However, such a drawback that the characters whose sizes are equal to or less than the predetermined font size appear or the like can be eliminated. Since it is possible to easily confirm that the characters whose sizes are equal to or less than the predetermined font size do not appear in accordance with the demand, the working efficiency of the print system can be improved.

[4] The execution error in the N-up printing in which the original images of a plurality of pages (N pages) are reconstructed on both sides of the sheet will now be described.

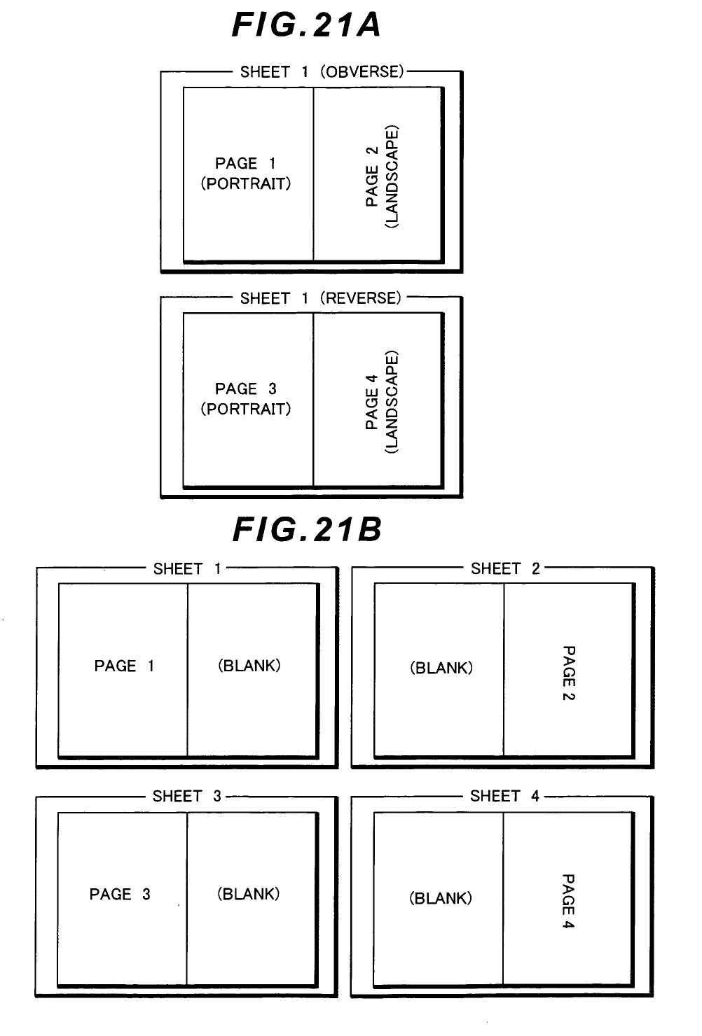

FIGS. 21A and 21B are explanatory diagrams of the format detection information of the inconvenient example [4].

FIG. 21A shows a normal state. FIG. 21B shows an inconvenient state. Explanation will now be made on the assumption that there are four original images and the N-up printing is limited to “2-up”. In the normal state as shown in FIG. 21A, the four original images are reconstructed onto the (obverse) and (reverse) of one sheet. That is, it is sufficient to use one sheet.

In FIG. 21B, since both the duplex printing and the 2-up printing are not executed, four sheets are used. In other words, the inconvenient state is detected by counting the number of sheets. It is assumed that those print format detection information and the discrimination reference have already been stored in the ROM 13 (FIG. 1).

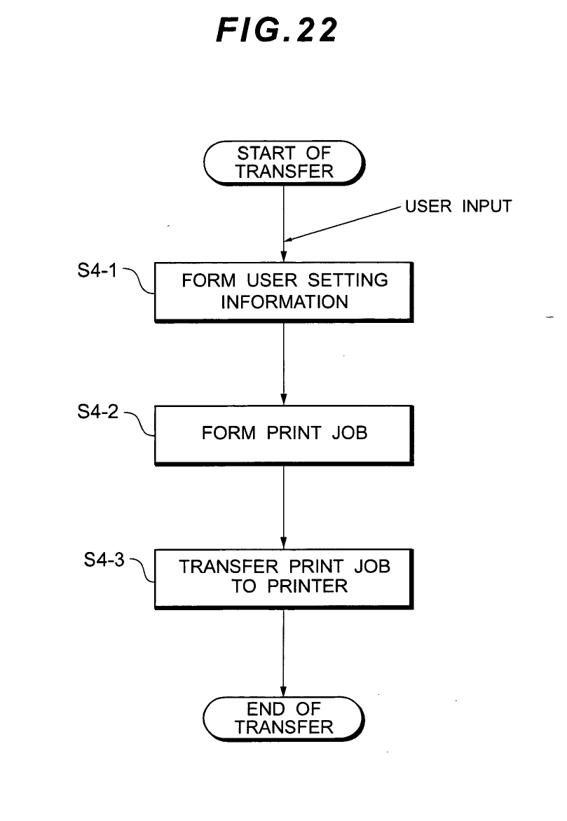

FIG. 22 is a flowchart (part 1) for the operation of the inconvenient example [4].

This flowchart relates to the operation of the image processing apparatus 30 (FIG. 2).

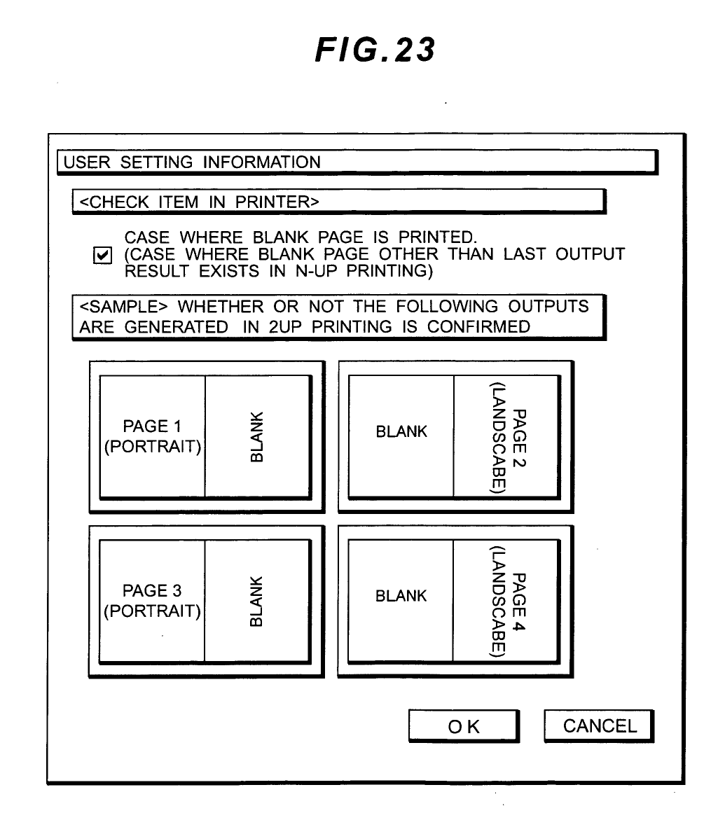

Step S4-1 FIG. 23 is a display diagram of the print format of the inconvenient example [4].

In the diagram, since both the duplex printing and the 2-up printing are not executed, four sheets are used.

The operator selects the user setting information from a property displayed on the display unit 22 (FIG. 2) by using the user I/F unit 21 (FIG. 2) and selects the state of FIG. 23 as a print format to be excluded.

When an OK button shown in FIG. 23 is clicked, the format to be excluded is immediately set by the user setting information forming unit 23 (FIG. 2). This step corresponds to the user setting information forming step 27-1.

Step S4-2

The print data forming unit 24 converts the document inputted by the operator or other information into the print data, data format information, user setting information, or the like and forms the print job.

Step S4-3

The print job is sent to the image forming apparatus 20 (FIG. 2) from the transmitting unit 25 (FIG. 2).

Steps S4-2 and S4-3 correspond to the user setting information transmitting step 27-2.

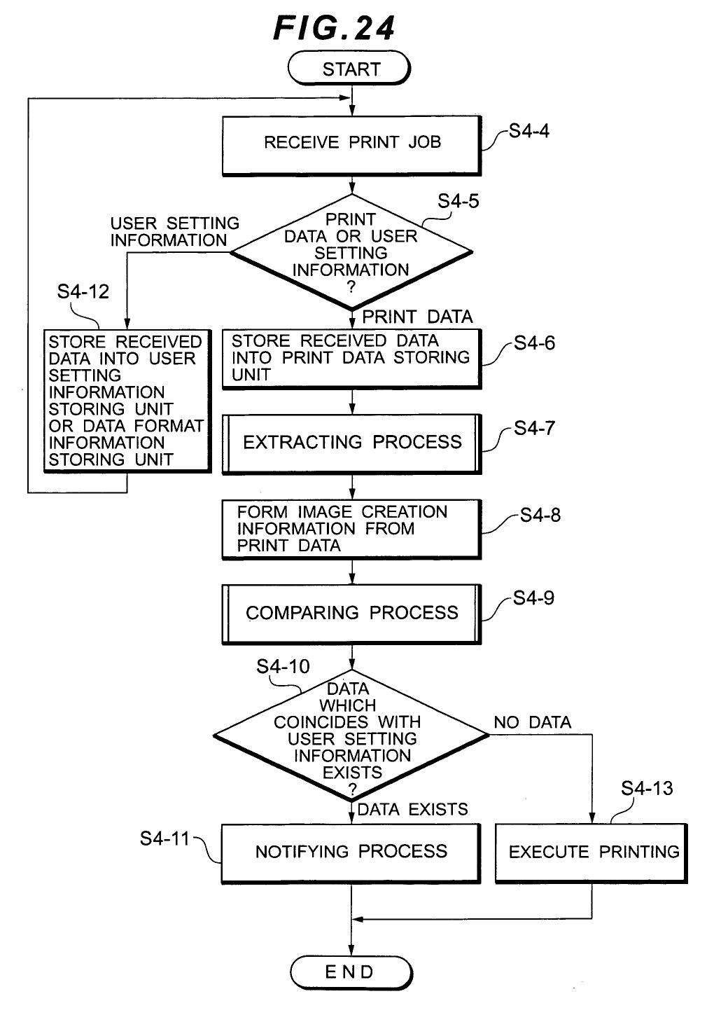

FIG. 24 is a flowchart (part 2) for the operation of the inconvenient example [4].

This diagram relates to the operation of the image forming apparatus 20 (FIG. 1).

Step S4-4

The receiving unit 1 (FIG. 1) receives the print job from the image processing apparatus 30 (FIG. 1).

Step S4-5

The discriminating unit 2 (FIG. 1) discriminates the type of print job received from the image processing apparatus 30 (FIG. 1), that is, it discriminates one of the user setting information, the print data, and the data format information. If the print data is discriminated, the processing routine advances to step S4-6. If either the user setting information or the data format information other than the print data is discriminated, step S4-12 follows. This step corresponds to the information type discriminating step 12-1 (FIG. 1).

Step S4-6

The print data is stored in the print data storing unit 3 (FIG. 1).

Step S4-7

The extracting unit 7 (FIG. 1) reads out the format to be excluded from the user setting information stored in the user setting information storing unit 4 (FIG. 1) and extracts the feature of the print format corresponding to the format to be excluded from the print data.

This step corresponds to the print format feature extracting step 12-2 (FIG. 1). Details of this step will be described again hereinafter.

Step S4-8

The image creation information forming unit 6 (FIG. 1) converts the print data into the bit map data (image creation information).

Step S4-9

The comparing unit 8 (FIG. 1) executes the operation for comparing the feature of the print format extracted in step S4-7 with the format to be excluded. This step corresponds to the feature comparing step 12-3 (FIG. 1). Details of this step will be described again hereinafter.

Step S4-10

The comparing unit 8 (FIG. 1) discriminates whether or not the expressing format to be excluded coincides with the feature of the print format on the basis of the predetermined discrimination reference from a comparison result. If they coincide, step S4-11 follows. If they do not coincide, step S4-13 follows. This step corresponds to the comparison result discriminating step 12-4 (FIG. 1).

Step S4-11

The notification showing that the print format of the print data coincides with the format to be excluded is transmitted from the transmitting unit 9 (FIG. 1) via the receiving unit 26 (FIG. 2) of the image processing apparatus 30 (FIG. 2) and displayed onto the display unit 22 (FIG. 2), and the processing flow is finished. This step corresponds to the re-edition requesting step 12-5 (FIG. 1).

Step S4-12

The user setting information is stored into the user setting information storing unit 4 (FIG. 1) and the data format information is stored into the data format information storing unit 5 (FIG. 1), respectively. After that, the processing routine is returned to step S4-4.

Step S4-13

The print control unit 10 (FIG. 1) controls the printing unit 11 and executes the printing process and the processing flow is finished.

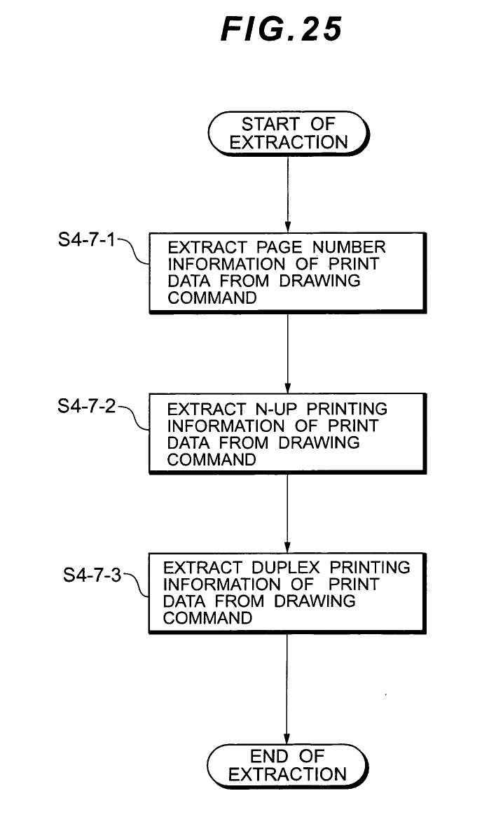

FIG. 25 is a flowchart for the extracting process of the inconvenient example [4].

Details of the print format feature extracting step 12-2 (FIG. 1) of step S4-7 will be described with reference to FIG. 25.

Explanation will be made by limiting to the case where original images of four pages are printed onto a sheet of the A4 letter size in the 2-up layout and in the duplex printing mode.

Step S4-7-1

The extracting unit 7 (FIG. 1) extracts information showing that the number of pages of the original is equal to 4 from the print data.

Step S4-7-2

The extracting unit 7 (FIG. 1) extracts the 2-up print information from the print data.

Step S4-7-3

The extracting unit 7 (FIG. 1) extracts the duplex printing information from the print data and the processing routine advances to step S4-8 (FIG. 24).

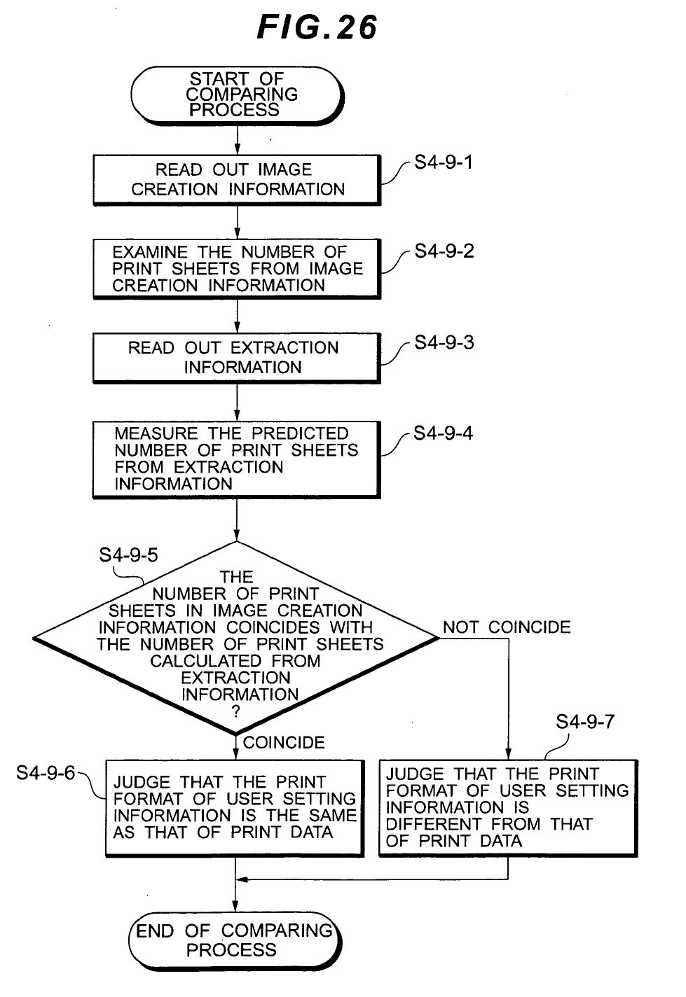

FIG. 26 is a flowchart for the comparing process of the inconvenient example [4].

Details of the feature comparing step 12-3 (FIG. 1) of step S4-9 will be described with reference to FIG. 26.

Step S4-9-1

The comparing unit 8 (FIG. 1) receives the bit map data (image creation information) from the image creation information forming unit 6 (FIG. 1).

Step S4-9-2

The comparing unit 8 (FIG. 1) detects the number of necessary print pages from the bit map data.

Step S4-9-3

The comparing unit 8 (FIG. 1) receives the extracted information from the extracting unit 7 (FIG. 1). The number “4” of original images, the 2-up printing, and the duplex printing are received here.

Step S4-9-4

In the comparison result discriminating step 12-4 (FIG. 1) of the control unit 12 (FIG. 1), the predicted number of sheets which will be necessary in the 2-up printing and the duplex printing is calculated. In this instance, “1” is calculated.

Step S4-9-5

The comparing unit 8 (FIG. 1) compares the number of sheets which were actually used with the predicted number of sheets. If they coincide, Step S4-9-6 follows. If they do not coincide, Step S4-9-7 follows.

Step S4-9-6

When it is recognized that the number of sheets which were actually used coincides with the predicted number of sheets, Step S4-13 (FIG. 24) follows.

Step S4-9-7

When it is recognized that the number of sheets which were actually used does not coincide with the predicted number of sheets, Step S4-11 (FIG. 24) follows.

As described above, if [4] the execution error in the N-up printing in which the original images of a plurality of pages (N pages) are reconstructed on both sides of the sheet is detected, a notification showing that the print format of the print data coincides with the format to be excluded is sent to the image processing apparatus (FIG. 2) from the image forming apparatus 20 (FIG. 1) and the processing flow is finished. If the execution error is not detected, the printing process is started as it is.

In the inconvenient examples [1] to [4] described above, nothing is mentioned with respect to a point that the image forming apparatus 20 (FIG. 1) returns the print data converted into the bit map data to the image processing apparatus 30 (FIG. 2) through the transmitting unit 9 (FIG. 1). However, the invention is not limited only to the control procedure described above. Naturally, in the invention, in addition to the foregoing control procedure, the print data converted into the bit map data can be also returned as necessary.

In such a case, an empty capacity of the storing unit 28 (FIG. 2) provided for the image processing apparatus 30 (FIG. 2) is read out by the transmitting unit 9 (FIG. 1). The bit map data of the amount corresponding to the empty capacity is sent to the image processing apparatus 30 (FIG. 2) from the image forming apparatus 20 (FIG. 1). For this purpose, only the page in which an error has occurred is selected or, if a plurality of errors exist, only one of the errors is selected. Further, the bit map data to be transmitted can be also compressed. All of those processes are executed by the control unit 12 (FIG. 1).

The present invention is not limited to the foregoing embodiments but many modifications and variations are possible within the spirit and scope of the appended claims of the invention.

1. A print control method of an image forming apparatus, comprising the steps of:
setting a feature condition, as a setting feature condition, of an image which is designated from an image processing apparatus;
extracting a feature portion from image data received from said image processing apparatus and discriminating whether or not said feature portion satisfies said setting feature condition; and
if it is determined that said feature portion satisfies said setting feature condition, notifying said image processing apparatus of such a fact.

2. The print control method according to claim 1, wherein said notification denotes that re-editing of said image data is obtained.

3. The print control method according to claim 1, wherein in said discriminating step, whether or not said feature portion satisfies said setting feature condition is discriminated on a unit basis of a page which is printed by said image forming apparatus, and
in said notifying step, if it is determined that said feature portion satisfies said setting feature condition, corresponding page information is notified on a unit basis of the page which is printed by said image forming apparatus.

4. The print control method according to claim 1, wherein said setting feature condition is a boundary condition of a plurality of images.

5. The print control method according to claim 1, wherein said setting feature condition is directions of a plurality of images.

6. The print control method according to claim 1, wherein said setting feature condition is a character size.

7. The print control method according to claim 1, wherein said setting feature condition is a character size corresponding to a character font.

8. The print control method according to claim 1, wherein said setting feature condition is the number of media which are printed by said image forming apparatus.

9. An image forming apparatus comprising:
a feature condition inputting unit which sets a feature condition, as a setting feature condition, of an image which is designated from an image processing apparatus;
a feature condition discriminating unit which extracts a feature portion from image data received from said image processing apparatus and discriminates whether or not said feature portion satisfies said setting feature condition; and
a notifying unit which, if it is determined that said feature portion satisfies said setting feature condition, notifies said image processing apparatus of such a fact.

10. The image forming apparatus according to claim 9, wherein said notifying unit obtains re-editing of said image data from said image processing apparatus.

11. The image forming apparatus according to claim 9, wherein
said feature condition discriminating unit discriminates whether or not said feature portion satisfies said setting feature condition on a unit basis of a page which is printed by said image forming apparatus, and
if it is determined that said feature portion satisfies said setting feature condition, said notifying unit notifies said image processing apparatus of corresponding page information on a unit basis of the page which is printed by said image forming apparatus.

12. The image forming apparatus according to claim 9, wherein said setting feature condition is a boundary condition of a plurality of images.

13. The image forming apparatus according to claim 9, wherein said setting feature condition is directions of a plurality of images.

14. The image forming apparatus according to claim 9, wherein said setting feature condition is a character size.

15. The image forming apparatus according to claim 9, wherein said setting feature condition is a character size corresponding to a character font.

16. The image forming apparatus according to claim 9, wherein said setting feature condition is the number of media which are printed by said image forming apparatus.
